(19) United States
(12) Patent Application Publication
(10) Pub. No.: US 2006/0237969 A1
(43) Pub. Date: Oct. 26, 2006

(54) ENERGY-SAVING ENVIRONMENTALLY FRIENDLY GENERATING SYSTEM

(76) Inventor: Chu-Fu Lin, YongKang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/277,700

(22) Filed: Mar. 28, 2006

(30) Foreign Application Priority Data
Apr. 22, 2005 (TW) 94112927

(51) Int. Cl. H02K 7/18; F03G 7/08; F02B 63/04

(52) U.S. Cl. 290/1 R

(57) ABSTRACT

An energy-saving environmentally friendly generating system includes at least one starting system, a generating system, a transmission gear system, and at least one weighting system. Speed ratios of the transmission gear system are utilized, and an external power is used to start the starting system. The speed changes of large and small gears create torques for releasing energy that is multiple times of the primitive energy of the starting system. The weighting system rotates and creates a gravitational force to release multifold energy for counterbalancing the load of generating and the load of electricity consumption of the generating system. The generating system can thus be started. When the generating system reaches its rated generating speed, a portion of electricity is directly transmitted to the starting system, thereby achieving continuous operation for generating electricity.

### BACKGROUND OF THE INVENTION

1. Field of the Invention

The present invention relates to an energy-saving environmentally friendly generating system. The principle of large/small gears and relative theory are applied and a weighting system is utilized to counterbalance the load of generating. Rotational speed ratios of transmission gears are utilized and an external power source starts a starting system for continuously driving a generating system through the transmission gear system. When the generating system reaches its rated speed for generating, a portion of electricity is directly utilized to start the starting system and thus drives the generating system to operate. Namely, multifold energy is generated for starting the starting system based on the large/small relative theory. The flywheel weighting system generates multifold energy to counterbalance the load of generating and the load of electricity consumption of the generating system. Thus, continuous self operation for generating electricity and for supplying electricity is allowed as long as the electricity generated by the generating system is larger than the electricity consumed.

2. Description of the Related Art

Human can use energy. Human beings have learned the knowledge to use the strength of human body or animal as well as various natural energy sources such as the sun, wind, and water to generate energy for various jobs since the human race has appeared on the earth. Through evolution of civilization, human beings learn how to use coal, petroleum, natural gas, tides, and atomic energy to generate heat energy, electric energy, and mechanical energy for the purposes of creating a more comfortable life.

We continuously consume various types of energy resources in daily lives. We receive the solar energy from the moment the light of the dawn projects on our eyelids. Chemical energy resulting from digesting foods is consumed while working or bicycling to the school or work. Air conditioning in the office needs electricity. In brief, energy plays a very important role in our lives. Accordingly, how to efficiently use the limited energy resources is the most concern to modern scientists.

### BRIEF SUMMARY OF THE INVENTION

Applicant utilizes a mechanical structure and the principle of large/small relative theory to firstly make a starting system release multifold energy. Operation of a weighting system releases further multifold energy to counterbalance the load of generating and the load of electricity consumption of a generating system. The generating system is driven by a power source starting system through the starting system and a transmission gear system. When the generating system reaches its rated speed for generating, a portion of electricity is directly utilized to start the starting system through a wiring system, allowing continuous operation for generating electricity and for supplying electricity.

An objective of the present invention is to provide an energy-saving environmentally friendly generating system including a starting system that can be started by an external power source to release multifold energy for the most efficient use without using fuel, thereby saving energy.

Another objective of the present invention is to provide an energy-saving environmentally friendly generating system that utilize transmission energy through transmission by a transmission gear assembly, thereby obtaining a system that generates electricity through self operation.

Other objectives, advantages, and novel features of the invention will become more apparent from the following detailed description when taken in conjunction with the accompanying drawings.

### BRIEF DESCRIPTION OF THE DRAWING

FIG. 1 is a schematic diagram illustrating an energy-saving environmentally friendly generating system in accordance with the present invention.

### DETAILED DESCRIPTION OF THE INVENTION

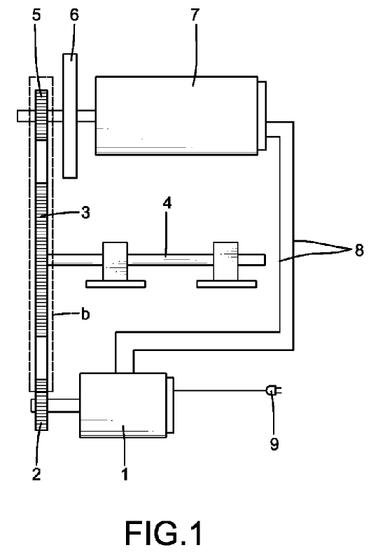

Referring to FIG. 1, an energy-saving environmentally friendly generating system in accordance with the present invention comprises at least one starting system 1, at least one transmission gear system b, at least one weighting system 6, a generating system 7, a wiring system 8, and a power source starting system 9. The transmission gear system b includes transmission gears 2, 3, and 5. The wiring system 8 is electrically connected to an output end of the generating system 7 and an input end of the starting system 1. Provision of various speed ratios through various speed rotational speeds and torques firstly releases multifold energy for starting the generating system 7 and the starting system 1. When the generating system 7 reaches the rated speed for generating, a portion of electricity is directly utilized to start the starting system for achieving self-operating generating functions, thereby saving the energy.

When the power source starting system 9 provides the primitive driving power source to starting the starting system 1 via a transmission gear system “b”, the speeds of the coaxial gears 2 and 3 vary to create torques, releasing multifold energy transmitted to the gear 5. The speed of the gear 5 changes and drives the weighting system 6 and the generating system 7 coaxial to the weighting system 6, achieving the generating purposes. The diameter of the gear 3 is greater than those of the gears 2 and 5. Since the speed change of the large and small gears may generate multifold energy and since rotation of the weighting system creates gravitational speed and thus generates multifold energy for counterbalancing the load of generating and the load of electricity consumption of the generating system 7, a portion of electricity is directly utilized to start the starting system 1 when the generating system 7 reaches the rated speed of generating and starts to generate, thereby generating and supplying electricity.

In practice, given the electricity generated by the generating system 7 is 4 KW, in a case that the starting system 1 requires 1 KW, the remaining electricity of about 3 KW can be utilized through the multifold energy obtained through the gear system having large and small gears 2, 3, and 5 and through the multifold energy that is obtained from operation of the weighting system 6 and that is utilized for generating operation.

In brief, the energy-saving environmentally friendly system in accordance with the present invention serves to save electricity and to fully utilize electricity. The remaining electricity can be recycled and utilized in the most efficient way. Nevertheless, the structure disclosed is merely an example of the present invention, not to limit the scope of the present invention. Numerous equivalent modifications and variations are still possible and covered by the accompanying claims without departing from the essence of the invention.

The following description further supports the present invention. Conventionally, the kinetic energy for starting a generating system is about 2 or 3 times of the operating power for generating purposes. Namely, 8-12 KW is required for starting a generating system that generates electricity at the operating power of 4 KW. Hence, it is impossible to start the generating system with a starting kinetic energy equal to the operating power.

Hence, the present invention is featured by utilizing a small-power starting system 1 to drive a large-power generating system 7 to operate and thus generate and supply electricity. The present invention utilizes the transmission gear system having large and small gears 2 and 3 to create torques through changes in rotational speeds, releasing energy that is multiple times of the kinetic energy of the starting system. Speed change is then applied to the gear 5 connected to the generating system 7 to provide the required rated speed and energy for generating purposes. Multifold energy is generated to counterbalance the load of generating and the load of electricity consumption of the generating system 7 through operation of the weighting system 6 that rotates to create a gravitational speed. Thus, the generating system 7 operatives normally and continuously for generating electricity that is supplied through the wiring system 8 to the starting system 1, and the remaining electricity can be output for use.

What is claimed is:

1. An energy-saving environmentally friendly generating system comprising at least one starting system, a generating system, a weighting system, a wiring system, and a transmission gear system, wherein:
the weighting system is a flywheel coaxially mounted to the generating system, the weighting system rotates and generates a gravitational speed for generating multifold energy for counterbalancing the load of generating and the load of consumption of electricity;
the generating system generates electricity;
the starting system is electrically connected to a primitive power source for starting and driving the generating system;
the wiring system is electrically connected to an output end of the generating system and an input end of the starting system;
the transmission gear system comprises a plurality of gears for transmitting the power from the generating system to the starting system; and
speed ratios of the transmission gear system are utilized to create torques and rotational speeds for releasing multifold energy, the power source starting system starts the starting system, when a rated generating speed is reached, a portion of electricity is transmitted via the wiring system to the starting system for directly starting the generating system through the transmission gear system, thereby obtaining self-operating generating functions and saving energy.
